(19) United States
(12) Patent Application Publication
(10) Pub. No.: US 2025/0104054 A1
(43) Pub. Date: Mar. 27, 2025

(54) BLOCKCHAIN-BASED METHOD FOR SAVING RESEARCH DATA

(71) Applicant: National Taiwan Normal University, Taipei City (TW)

(72) Inventor: Yun-Cheng TSAI, Taipei City (TW)

(73) Assignee: National Taiwan Normal University, Taipei City (TW)

(21) Appl. No.: 18/586,985

(22) Filed: Feb. 26, 2024

(30) Foreign Application Priority Data
Sep. 22, 2023 (TW) 112136224

(51) Int. Cl. G06Q 20/38; G06F 8/34; G06Q 20/36

(52) U.S. Cl. CPC G06Q 20/38215; G06F 8/34; G06Q 20/36; G06Q 20/389

(57) ABSTRACT

A blockchain-based method for saving research data is implemented by a processing system. The processing system is connected to a blockchain system, and stores a user account associated with the blockchain system. The method includes sending a deployment request that includes the user account and an application to the blockchain system, in order for the blockchain system to deploy the application associated with the user account on the blockchain system. The method further includes generating and sending a processing request that includes a to-be-processed dataset to the blockchain system, in order for the blockchain system to analyze the to-be-processed dataset using the application so as to obtain a target dataset that corresponds to the to-be-processed dataset and that indicates an analysis result of the to-be-processed dataset, to store the to-be-processed dataset and the target dataset in the blockchain system, and to send the target dataset to the processing system.

### CROSS-REFERENCE TO RELATED APPLICATION

This application claims priority to Taiwanese Invention Patent Application No. 112136224, filed on Sep. 22, 2023, and incorporated by reference herein in its entirety.

### FIELD

The disclosure relates to a method for storing information, and more particularly to a blockchain-based method for saving research data.

### BACKGROUND

During a research process, valuable research data may be produced, such as observation records, experiment records, and analysis results derived from the observation records and the experiment records. A conventional method for saving the research data requires the researcher to store the research data in an electronic device (e.g., a computer) or to record the research data on a research notebook. However, if the researcher loses the electronic device or the research notebook, the research data may be permanently lost. Furthermore, manually analyzing the observation records and the experiment records is not only time consuming, but may also introduce human errors to the analysis results.

### SUMMARY

Therefore, an object of the disclosure is to provide a blockchain-based method for saving research data that can alleviate at least one of the drawbacks of the prior art.

According to the disclosure, a blockchain-based method for saving research data is implemented by a processing system. The processing system is connected to a blockchain system through a communication network, and stores a user account associated with the blockchain system. The method includes sending a program deployment request that includes the user account and a target application program to the blockchain system, in order for the blockchain system to deploy the target application program that is associated with the user account on the blockchain system. The target application program is configured to generate an output dataset that indicates an analysis result of an input dataset. The method further includes generating and sending a processing request that includes a to-be-processed dataset to the blockchain system, in order for the blockchain system to analyze the to-be-processed dataset using the target application program so as to obtain a target dataset that corresponds to the to-be-processed dataset and that indicates an analysis result of the to-be-processed dataset, to store the to-be-processed dataset and the target dataset in the blockchain system, and to send the target dataset to the processing system.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a first electronic device, a second electronic device, a server, and a blockchain system implementing a blockchain-based method for saving research data according to an embodiment of the disclosure.

FIG. 2 is a flow chart illustrating a research data saving procedure of the blockchain-based method according to an embodiment of the disclosure.

FIG. 3 is a flow chart further illustrating the research data saving procedure of the blockchain-based method according to another embodiment of the disclosure.

FIGS. 4A and 4B illustrate a flow chart of a research data transferring procedure of the blockchain-based method according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

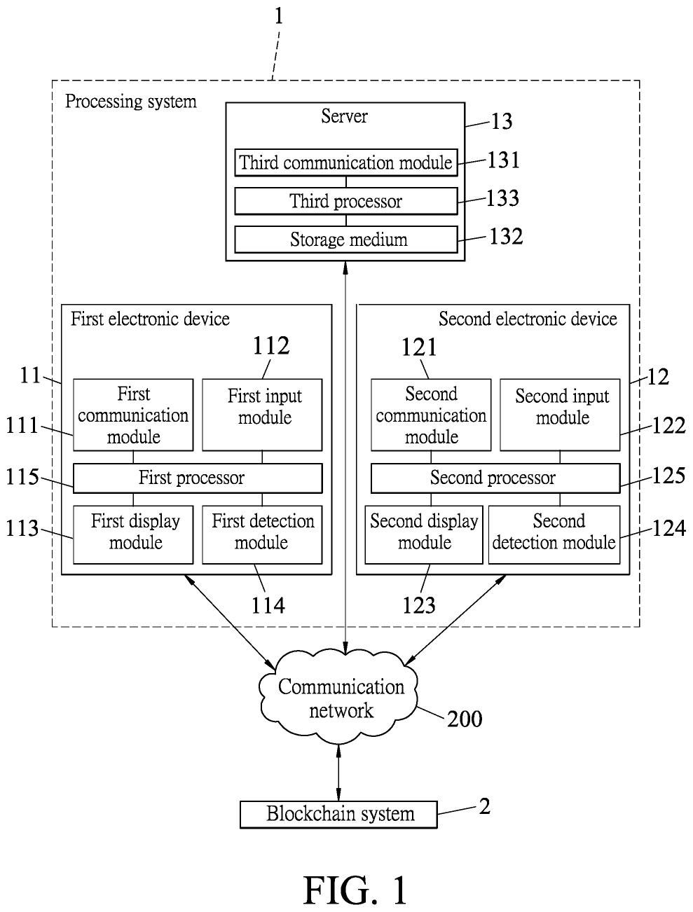

Referring to FIG. 1, a processing system 1 implementing a blockchain-based method for saving research data according to an embodiment of the disclosure is provided. The processing system 1 is connected to a blockchain system 2 through a communication network 200, and includes a first electronic device 11, a second electronic device 12, and a server 13 that is electrically connected to the first electronic device 11 and the second electronic device 12 through the communication network 200.

The first electronic device 11 includes a first communication module 111 that is configured to allow the first electronic device 11 to connect to the communication network 200, a first input module 112, a first display module 113, a first detection module 114, and a first processor 115 that is electrically connected to the first communication module 111, the first input module 112, the first display module 113, and the first detection module 114.

The second electronic device 12 includes a second communication module 121 that is configured to allow the second electronic device 12 to connect to the communication network 200, a second input module 122, a second display module 123, a second detection module 124, and a second processor 125 that is electrically connected to the second communication module 121, the second input module 122, the second display module 123, and the second detection module 124.

The server 13 includes a third communication module 131 that is configured to allow the server 13 to connect to the communication network 200, a storage medium 132, and a third processor 133 that is electrically connected to the third communication module 131 and the storage medium 132. The server 13 provides an editing interface for creating an application using a visual programming language. In this embodiment, the visual programming language is a block-based visual programming language (e.g., Google BLockly or Scratch), and the application is a smart contract, but the disclosure is not limited to such.

The storage medium 132 at least stores a user account and a target account that are associated with the blockchain system 2, and each of the user account and the target account is related to a virtual wallet for storing virtual currency. In practice, the storage medium 132 may store more accounts that are associated with the blockchain system 2.

The storage medium 132 may be computer-readable storage mediums such as hard disk drive(s), random access memory (RAM), read only memory (ROM), programmable ROM (PROM), and/or flash memory, etc.

The first electronic device 11 and the second electronic device 12 may each be a smart device, a laptop, a personal computer, etc. The first detection module 114 and the second detection module 124 may each be, but not limited to, a temperature sensor that periodically detects temperature, a humidity sensor that periodically detects humidity, a distance sensor that periodically detects a distance, a force sensor that periodically detects a force applied thereon, or a position sensor (e.g., a global positioning system (GPS) sensor) that periodically detects position information. The first display module 113 and the second display module 123 may be screens on the first electronic device 11 and the second electronic device 12, respectively.

The first communication module 111, the second communication module 121, and the third communication module 131 may each include one or more of a radio-frequency integrated circuit (RFIC), a short-range wireless communication module supporting a short-range wireless communication network using a wireless technology such as Bluetooth® and/or Wi-Fi, etc., and a mobile communication module supporting telecommunication using Long-Term Evolution (LTE), the third generation (3G), the fourth generation (4G) or fifth generation (5G) of the wireless mobile telecommunications technology, or the like.

The first processor 115, the second processor 125, and the third processor 133 may each be, but not limited to, a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), and/or a system on a chip (SoC), etc.

The blockchain system 2 is a public blockchain that is compatible with Ethereum protocol, such as a blockchain created with Polygon protocol, but the disclosure is not limited to such.

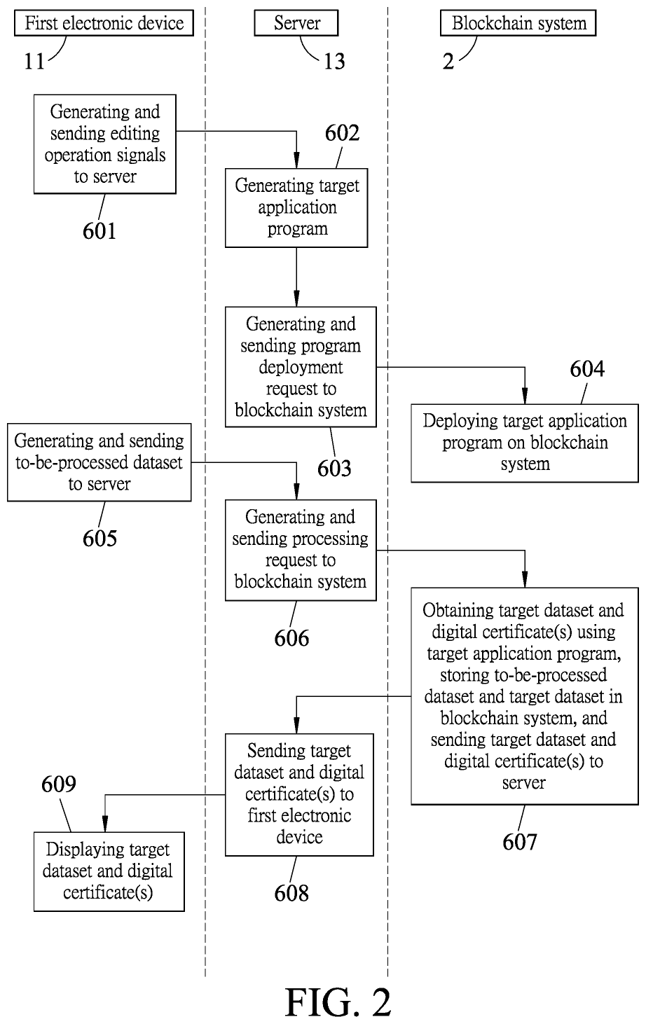

The blockchain-based method for saving research data includes a research data saving procedure and a research data transferring procedure. Referring to FIG. 2, the research data saving procedure includes steps 601 to 609. Before performing the research data saving procedure, a user has to log in on the first electronic device 11 with the user account to access the editing interface.

In step 601, the first processor 115 of the first electronic device 11 generates, based on an input operation from the user through the editing interface, a series of editing operation signals, and sends the editing operation signals to the server 13 through the first communication module 111. It should be noted that the server 13 provides the editing interface to the first electronic device 11 so that the user may perform the input operation by editing the visual programming language using the first input module 112 (e.g., a keyboard) on the editing interface.

In step 602, in response to receiving the editing operation signals from the first electronic device 11 through the third communication module 131, the third processor 133 of the server 13 generates, based on the editing operation signals, a target application program that is to be executed in the blockchain system 2 using the visual programming language. Since the editing operation signals are generated by the user operating the editing interface, which is accessed with the user account, the editing operation signals are generated to be associated with the user account.

It should be noted that the target application program is configured to analyze an input dataset and then generate an output dataset that indicates an analysis result of the input dataset, and is further configured to generate either a digital certificate that indicates an ownership of the input dataset, or a digital certificate that indicates an ownership of the output dataset. The target application program is further configured to, when a certificate transfer condition is met, transfer a digital certificate that belongs to one account to another account.

In this embodiment, each digital certificate is a non-fungible token (NFT), but the disclosure is not limited to such.

In step 603, the third processor 133 of the server 13 generates a program deployment request that includes the user account and the target application program, and sends the program deployment request to the blockchain system 2 through the third communication module 131. It should be noted that the user account included in the program deployment request is an account that creates the target application program (i.e., the account that is logged in on a device used for generating the editing operation signals).

In step 604, upon receiving the program deployment request from the server 13, the blockchain system 2 deploys the target application program on the blockchain system 2 based on the program deployment request. That is to say, the blockchain system 2 deploys the smart contract (i.e., the target application program) that is associated with the user account on the blockchain system 2, so that the target application program may be automatically executed on the blockchain system 2. Since the deployment and execution of the smart contract on a blockchain network is not the emphasis of this disclosure and is well-known to one having ordinary skill in the art, it will not be described in further detail for the sake of brevity.

In step 605, the first processor 115 generates, based on external information detected by the first detection module 114 (e.g., a sensor), a to-be-processed dataset that is associated with the user account, and sends the to-be-processed dataset to the server 13 through the first communication module 111. It should be noted that the first detection module 114 automatically generates and sends the to-be-processed dataset to the server 13, without manual input from the user, thus enhancing the convenience of recording the to-be-processed dataset, and preventing from human errors associated with manual data entry.

In step 606, upon receiving the to-be-processed dataset from the first electronic device 11 through the third communication module 131, the third processor 133 generates a processing request that includes the to-be-processed dataset, and sends the processing request to the blockchain system 2 through the third communication module 131.

In step 607, upon receiving the processing request from the server 13, the blockchain system 2 analyzes the to-be-processed dataset using the target application program so as to obtain a target dataset that corresponds to the to-be-processed dataset and that indicates an analysis result of the to-be-processed dataset. The blockchain system 2 then stores the to-be-processed dataset and the target dataset in the blockchain system 2, and sends the target dataset thus generated to the server 13. The blockchain system 2 further generates, using the target application program, a first digital certificate and/or a second digital certificate, and sends the first digital certificate and/or the second digital certificate to the server 13. Specifically, the first digital certificate indicates that an ownership of the to-be-processed dataset belongs to the user account, and the second digital certificate indicates that an ownership of the target dataset belongs to the user account.

In step 608, upon receiving the target dataset from the blockchain system 2 through the third communication module 131, the third processor 133 of the server 13 sends the target dataset to the first electronic device 11 through the third communication module 131. The third processor 133 further sends the first digital certificate and/or the second digital certificate thus received in step 607 to the first electronic device 11 through the third communication module 131.

In step 609, after receiving the target dataset through the first communication module 111, the first processor 115 of the first electronic device 11 controls the first display module 113 to display the target dataset. Additionally, the first processor 115 further controls the first display module 113 to display the first digital certificate and/or the second digital certificate thus received in step 608.

In one example, the first detection module 114 is a humidity sensor that is configured to detect ambient humidity and to generate a humidity dataset based on the ambient humidity, and the target application program is for analyzing the humidity dataset (i.e., the to-be-processed dataset) so as to obtain a water dataset (i.e., the target dataset) that is related to a watering amount of a plant. It should be noted that steps 605 to 609 may be performed repeatedly so as to obtain different target datasets that correspond respectively to different to-be-processed datasets, and the target datasets and the to-be-processed datasets may be stored in the blockchain system 2 in real time, but the disclosure is not limited to such.

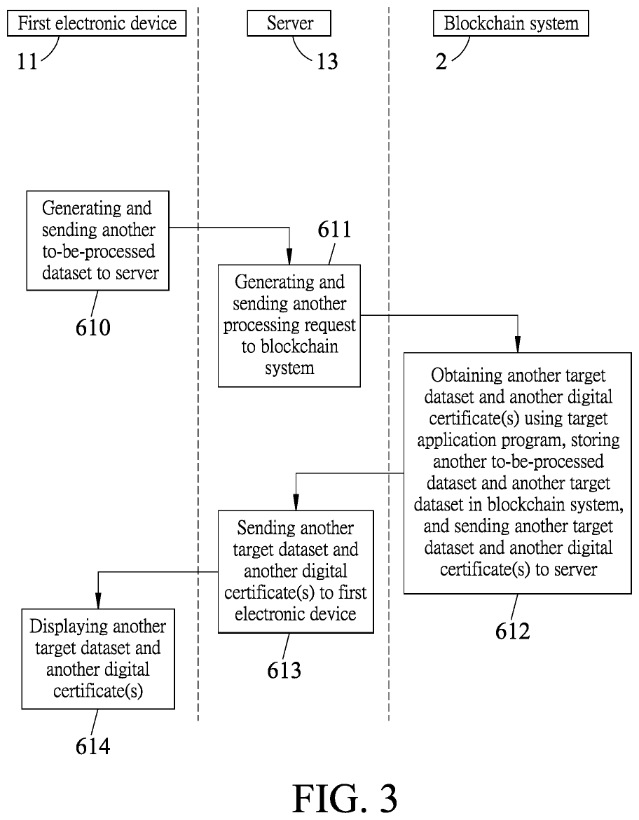

Further referring to FIG. 3, in some embodiments, when the first detection module 114 further detects another external information, the method further includes steps 610 to 614.

In step 610, the first processor 115 of the first electronic device 11 generates, based on said another external information detected by the first detection module 114, another to-be-processed dataset that is associated with the user account, and sends said another to-be-processed dataset to the server 13 through the first communication module 111.

In step 611, upon receiving said another to-be-processed dataset from the first electronic device 11 through the third communication module 131, the third processor 133 of the server 13 generates another processing request that includes said another to-be-processed dataset, and sends said another processing request to the blockchain system 2 through the third communication module 131.

In step 612, upon receiving said another processing request from the server 13, the blockchain system 2 analyzes said another to-be-processed dataset using the target application program, so as to obtain another target dataset that corresponds to said another to-be-processed dataset and that indicates an analysis result associated with said another to-be-processed dataset. The blockchain system 2 then stores said another to-be-processed dataset and said another target dataset in the blockchain system 2, and sends said another target dataset thus generated to the server 13. The blockchain system 2 further generates, using the target application program, a third digital certificate and/or a fourth digital certificate, and sends the third digital certificate and/or the fourth digital certificate to the server 13. Specifically, the third digital certificate indicates that an ownership of said another to-be-processed dataset belongs to the user account, and the fourth digital certificate indicates that an ownership of said another target dataset belongs to the user account.

In step 613, upon receiving said another target dataset from the blockchain system 2 through the third communication module 131, the third processor 133 of the server 13 sends said another target dataset to the first electronic device 11 through the third communication module 131. The third processor 133 further sends the third digital certificate and/or the fourth digital certificate thus received in step 612 to the first electronic device 11 through the third communication module 131.

In step 614, after receiving said another target dataset through the first communication module 111, the first processor 115 of the first electronic device 11 controls the first display module 113 to display said another target dataset. Additionally, the first processor 115 further controls the first display module 113 to display the third digital certificate and/or the fourth digital certificate thus received in step 613.

It should be noted that, similar to steps 605 to 609, steps 610 to 614 may also be performed repeatedly so as to store different entries of said another to-be-processed datasets and different entries of said another target datasets in the blockchain system 2.

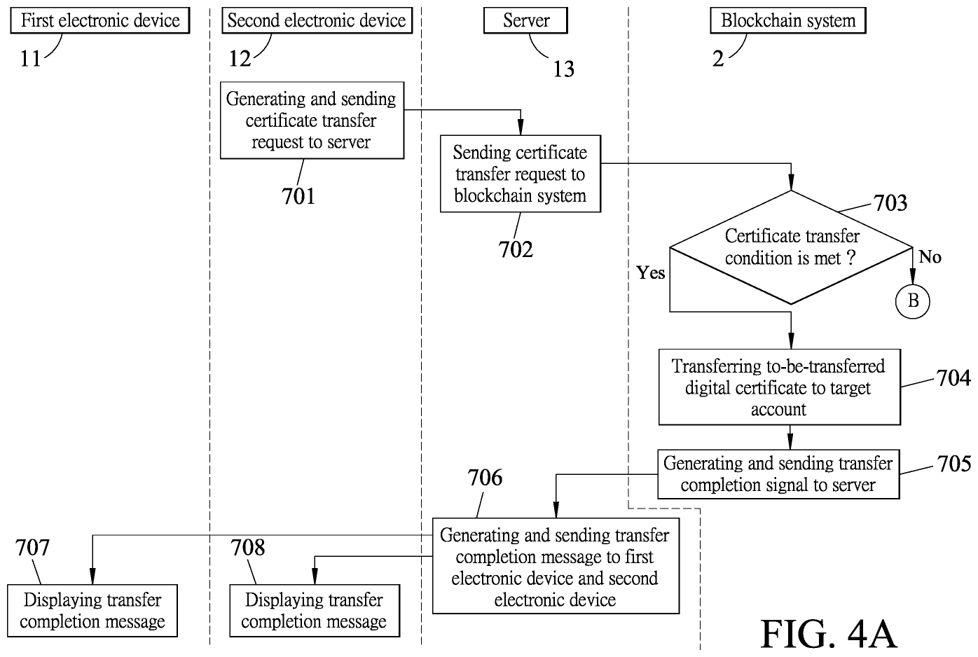

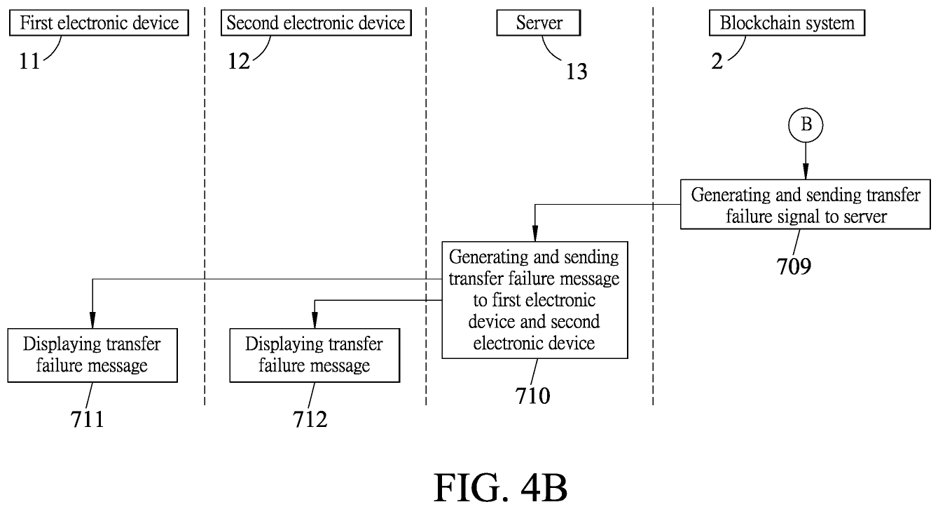

Referring to FIGS. 4A and 4B, the research data transferring procedure includes steps 701 to 712. Before performing the research data transferring procedure, another user is logged in on the second electronic device 12 with the target account.

In step 701, the second processor 125 of the second electronic device 12 generates, in response to an input signal generated by said another user on the second electronic device 12 using the second input module 122 (e.g., a keyboard), a certificate transfer request for transferring a to-be-transferred digital certificate to the target account, and sends the certificate transfer request to the server 13 through the second communication module 121. The to-be-transferred digital certificate is one of the first digital certificate and the second digital certificate generated in step 607, or one of the third digital certificate and the fourth digital certificate generated in step 612.

In step 702, upon receiving the certificate transfer request from the second electronic device 12 through the third communication module 131, the third processor 133 of the server 13 sends the certificate transfer request to the blockchain system 2 through the third communication module 131.

In step 703, upon receiving the certificate transfer request, the blockchain system 2 determines, using the target application program, whether the certificate transfer condition is met based on the certificate transfer request. When the blockchain system 2 determines that the certificate transfer condition is met, the flow proceeds to step 704; otherwise, the flow proceeds to step 709.

It should be noted that, in this embodiment, the certificate transfer condition is that a total amount of the virtual currency in the virtual wallet related to the target account (hereinafter referred to as “target wallet”) is not less than a predetermined amount. When the blockchain system 2 determines that the total amount of the virtual currency in the target wallet is not less than the predetermined amount, the flow proceeds to step 704; otherwise, the flow proceeds to step 709.

In some embodiments, the certificate transfer condition is that a current time point has passed a predetermined time point. When the blockchain system 2 determines that the current time point has passed the predetermined time point, the flow proceeds to step 704; otherwise, the flow proceeds to step 709.

In step 704, the blockchain system 2 transfers, using the target application program, the to-be-transferred digital certificate to the target account. To describe in further detail, once the to-be-transferred digital certificate is transferred to the target account, the ownership of the dataset (i.e., either the to-be-processed dataset or the target dataset) that is related to the to-be-transferred digital certificate shifts from the user account to the target account. In this embodiment, the blockchain system 2 further transfers an amount of the virtual currency that is equal to the predetermined amount from the target wallet to the virtual wallet related to the user account.

In step 705, the blockchain system 2 generates and sends a transfer completion signal to the server 13, where the transfer completion signal indicates that the to-be-transferred digital certificate has been transferred from the user account to the target account.

In step 706, upon receiving the transfer completion signal from the blockchain system 2 through the third communication module 131, the third processor 133 of the server 13 generates, based on the transfer completion signal, a transfer completion message indicating that the to-be-transferred digital certificate has been transferred from the user account to the target account, and sends the transfer completion message to the first electronic device 11 and the second electronic device 12 through the third communication module 131.

In step 707, upon receiving the transfer completion message from the server 13 through the first communication module 111, the first processor 115 of the first electronic device 11 controls the first display module 113 to display the transfer completion message.

In step 708, upon receiving the transfer completion message from the server 13 through the second communication module 121, the second processor 125 of the second electronic device 12 controls the second display module 123 to display the transfer completion message.

In step 709, the blockchain system 2 generates and sends a transfer failure signal indicating that the certificate transfer condition has not been met to the server 13.

In step 710, upon receiving the transfer failure signal from the blockchain system 2 through the third communication module 131, the third processor 133 of the server 13 generates, based on the transfer failure signal, a transfer failure message indicating that the certificate transfer condition has not been met and that the to-be-transferred digital certificate is not transferred from the user account to the target account, and sends the transfer failure message to the first electronic device 11 and the second electronic device 12 through the third communication module 131.

In step 711, upon receiving the transfer failure message from the server 13 through the first communication module 111, the first processor 115 of the first electronic device 11 controls the first display module 113 to display the transfer failure message.

In step 712, upon receiving the transfer failure message from the server 13 through the second communication module 121, the second processor 125 of the second electronic device 12 controls the second display module 123 to display the transfer failure message.

In summary, according to the disclosure, the server 13 provides the editing interface for creating the target application program using the visual programming language, and the user may operate on the first electronic device 11 that is electrically connected to the server 13 to create the target application program through the editing interface, and to deploy the target application program on the blockchain system 2. Then, the to-be-processed dataset generated by the first electronic device 11 may be sent to the blockchain system 2 through the server 13, so that the blockchain system 2 uses the target application program to analyze the to-be-processed dataset so as to obtain the target dataset that corresponds to the to-be-processed dataset. The blockchain system 2 then, using the target application program, stores the to-be-processed dataset and the corresponding target dataset in the blockchain system 2, and generates the first target digital certificate and/or the second target digital certificate that correspond respectively to the to-be-processed dataset and the target dataset. As such, the method of the disclosure ensures that the to-be-processed dataset and the target dataset are not tampered with, and enables transferring of research data and analysis results between two accounts through transferring the first target digital certificate and/or the second target digital certificate.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A blockchain-based method for saving research data, the method being implemented by a processing system that is connected to a blockchain system through a communication network and that stores a user account associated with the blockchain system, the method comprising:
sending a program deployment request that includes the user account and a target application program to the blockchain system, in order for the blockchain system to deploy the target application program that is associated with the user account on the blockchain system, the target application program being configured to generate an output dataset that indicates an analysis result of an input dataset; and
generating and sending a processing request that includes a to-be-processed dataset to the blockchain system, in order for the blockchain system to analyze the to-be-processed dataset using the target application program so as to obtain a target dataset that corresponds to the to-be-processed dataset and that indicates an analysis result of the to-be-processed dataset, to store the to-be-processed dataset and the target dataset in the blockchain system, and to send the target dataset to the processing system.

2. The blockchain-based method as claimed in claim 1, the processing system providing an editing interface for creating an application using a visual programming language,
the method further comprising, before sending a program deployment request to the blockchain system, generating the target application program that is to be executed in the blockchain system using the visual programming language based on a series of editing operation signals, where the editing operation signals are generated based on an input operation from a user through the editing interface.

3. The blockchain-based method as claimed in claim 2, wherein the visual programming language is a block-based visual programming language.

4. The blockchain-based method as claimed in claim 2, the processing system including a first electronic device, and a server that is electrically connected to the first electronic device through the communication network and that provides the editing interface to the first electronic device, wherein generating the target application program includes:
the first electronic device generating and sending the editing operation signals to the server, where the editing operation signals are generated based on the input operation from the user through the editing interface; and
the server, in response to receiving the editing operation signals from the first electronic device, generating the target application program that is to be executed in the blockchain system using the visual programming language.

5. The blockchain-based method as claimed in claim 4, wherein generating and sending a processing request to the blockchain system includes:
the first electronic device generating and sending the to-be-processed dataset to the server;
the server, after receiving the to-be-processed dataset from the first electronic device, generating the processing request based on the to-be-processed dataset and sending the processing request to the blockchain system, in order for the blockchain system to analyze the to-be-processed dataset using the target application program so as to obtain the target dataset, to store the to-be-processed dataset and the target dataset in the blockchain system, and to send the target dataset to the server; and
the server, after receiving the target dataset from the blockchain system, sending the target dataset to the first electronic device that is associated with the user account.

6. The blockchain-based method as claimed in claim 4, wherein:
the target application program is further configured to cause the blockchain system to, after the blockchain system generates the target dataset in response to receiving the processing request, generate and send a digital certificate to the processing system using the target application program, and wherein the digital certificate indicates that an ownership of the to-be-processed dataset belongs to the user account.

7. The blockchain-based method as claimed in claim 6, further comprising:
after generating and sending a processing request to the blockchain system, the processing system generating and sending another processing request that includes another to-be-processed dataset to the blockchain system, in order for the blockchain system to analyze said another to-be-processed dataset using the target application program so as to obtain another target dataset that corresponds to said another to-be-processed dataset and that indicates an analysis result of said another to-be-processed dataset, to store said another to-be-processed dataset and said another target dataset in the blockchain system, to send said another target dataset to the processing system, and to generate and send another digital certificate to the processing system using the target application program, where said another digital certificate indicates that an ownership of said another to-be-processed dataset belongs to the user account.

8. The blockchain-based method as claimed in claim 6, the processing system further including a second electronic device that is associated with a target account and that is electrically connected to the server through the communication network, the target account being associated with the blockchain system;
the method further comprising, after generating and sending a processing request to the blockchain system:
the second electronic device generating and sending to the server a certificate transfer request for transferring a to-be-transferred digital certificate that is associated with the user account to the target account; and
the server, after receiving the certificate transfer request, sending the certificate transfer request to the blockchain system, in order for the blockchain system, using the target application program, to determine whether a certificate transfer condition is met, and when determining that the certificate transfer condition is met, to transfer the to-be-transferred digital certificate from the user account to the target account.

9. The blockchain-based method as claimed in claim 8, each of the user account and the target account being related to a virtual wallet for storing virtual currency, wherein:
the certificate transfer condition is that a total amount of the virtual currency in the virtual wallet corresponding to the target account is not less than a predetermined amount; and
sending the certificate transfer request to the blockchain system further causes the blockchain system to, after transferring the to-be-transferred digital certificate to the target account, transfer an amount of the virtual currency that is equal to the predetermined amount from the virtual wallet corresponding to the target account to the virtual wallet corresponding to the user account.

10. The blockchain-based method as claimed in claim 4, wherein:
the target application program is further configured to cause the blockchain system to, after the blockchain system generates the target dataset in response to receiving the processing request, generate and send a digital certificate to the processing system using the target application program, and wherein the digital certificate indicates that an ownership of the target dataset belongs to the user account.

11. The blockchain-based method as claimed in claim 10, further comprising:
after generating and sending a processing request to the blockchain system, the processing system generating and sending another processing request that includes another to-be-processed dataset to the blockchain system, in order for the blockchain system to analyze said another to-be-processed dataset using the target application program so as to obtain another target dataset that corresponds to said another to-be-processed dataset and that indicates an analysis result of said another to-be-processed dataset, to store said another to-be-processed dataset and said another target dataset in the blockchain system, to send said another target dataset to the processing system, and to generate and send another digital certificate to the processing system using the target application program, where said another digital certificate indicates that an ownership of said another target dataset belongs to the user account.

12. The blockchain-based method as claimed in claim 10, the processing system further including a second electronic device that is associated with a target account and that is electrically connected to the server through the communication network, the target account being associated with the blockchain system,
the method further comprising, after generating and sending a processing request to the blockchain system:
the second electronic device generating and sending to the server a certificate transfer request for transferring a to-be-transferred digital certificate that is associated with the user account to the target account; and
the server, after receiving the certificate transfer request, sending the certificate transfer request to the blockchain system, in order for the blockchain system, using the target application program, to determine whether a certificate transfer condition is met, and when determining that the certificate transfer condition is met, to transfer the to-be-transferred digital certificate from the user account to the target account.

13. The blockchain-based method as claimed in claim 12, each of the user account and the target account including a virtual wallet for storing virtual currency, wherein:
the certificate transfer condition is that a total amount of the virtual currency in the virtual wallet corresponding to the target account is not less than a predetermined amount; and
sending the certificate transfer request to the blockchain system further causes the blockchain system to, after transferring the to-be-transferred digital certificate to the target account, transfer an amount of the virtual currency that is equal to the predetermined amount from the virtual wallet corresponding to the target account to the virtual wallet corresponding to the user account.

14. The blockchain-based method as claimed in claim 4, the first electronic device including a sensor,
wherein generating and sending a processing request that includes a to-be-processed dataset to the blockchain system includes the sensor generating the to-be-processed dataset.
